(19) United States
(12) Patent Application Publication
(10) Pub. No.: US 2025/0314994 A1
(43) Pub. Date: Oct. 9, 2025

(54) IMAGE FORMING APPARATUS

(71) Applicant: CANON KABUSHIKI KAISHA, Tokyo (JP)

(72) Inventor: KENTA MATSUZAKI, Chiba (JP)

(21) Appl. No.: 19/170,759

(22) Filed: Apr. 4, 2025

(30) Foreign Application Priority Data
Apr. 8, 2024 (JP) 2024-062417

(51) Int. Cl. G03G 15/16

(52) U.S. Cl. CPC G03G 15/1615; G03G 15/161; G03G 2215/1661

(57) ABSTRACT

An image forming apparatus includes an image bearing member, an intermediate transfer belt, a cleaning blade configured to clean toner remaining on an outer peripheral surface of the intermediate transfer belt, a scraper configured to come into contact with the outer peripheral surface of the intermediate transfer belt at a second contact portion downstream of the first contact portion in a rotation direction of the intermediate transfer belt, a driving source configured to drive the intermediate transfer belt in normal and reverse rotation, and a control unit configured to control the driving source so that a reverse rotation operation is executed, wherein the scraper is provided on a lower surface of the intermediate transfer belt, and the control unit controls the driving source so that a moving distance of the intermediate transfer belt in the reverse rotation operation is longer than a circumferential distance L of the intermediate transfer belt.

### BACKGROUND

### Technical Field

The present disclosure relates to an image forming apparatus equipped with a cleaning blade that comes into contact with and cleans a surface of an image-bearing member and a scraper that comes into contact with and cleans the surface of the image-bearing member.

### Description of the Related Art

A conventional electrophotographic method image forming apparatus includes a cleaning apparatus that removes (cleans) residual toner adhering to a surface of an image-bearing member such as a photosensitive member or an intermediate transfer belt after a toner image is transferred to a recording sheet. The cleaning apparatus includes a cleaning member that comes into contact with the surface of the image-bearing member to remove the residual toner, and in addition to the toner, it also cleans an external additive added to the toner and paper dust peeled off from the recording sheet, which adhere to the surface of the image-bearing member.

The external additive usually has a smaller particle diameter than that of the toner and is difficult to be cleaned off. If the external additive cannot be sufficiently removed, filming may occur in which the additive adheres to the surface of the image-bearing member in a film state. In a case where a blade-shaped cleaning member (cleaning blade) is used, the occurrence of filming may increase frictional resistance between the image-bearing member and the cleaning blade, turn up a tip end of the blade, and cause cleaning failure.

If the external additive and paper dust cannot be sufficiently removed, charged potential of the surface of the image-bearing member decreases, which may cause transfer failure or an image defect. Further, if paper dust enters a contact portion between the cleaning blade and the image-bearing member, the paper dust may be caught in the contact portion and lead to cleaning failure where the toner passes through the portion where the paper dust is caught.

According to Japanese Patent Application Laid-Open No. 2004-347864, a cleaning apparatus that cleans a surface of an endless belt is discussed. The endless belt is cleaned by a cleaning brush that rotates in contact with a surface of an image-bearing member and collects toner on the surface of the image-bearing member. Then, a scraper collects the uncollected toner and paper dust.

In a case of the configuration discussed in Japanese Patent Application Laid-Open No. 2004-347864, because a scraper with high hardness is used, the belt surface may be scraped by sliding of a cleaning member, resulting in generation of scraped powder. The scraped powder may be caught in a contact portion of the scraper and damage the belt surface.

### SUMMARY

The present disclosure is directed to the provision of an image forming apparatus equipped with a scraper that removes an adhering substance adhering to a surface of an image-bearing member and capable of efficiently removing a deposited substance deposited on a contact portion of the scraper with a simple configuration.

According to an aspect of the present disclosure, an image forming apparatus includes an image-bearing member configured to rotate and bear a toner image, an intermediate transfer belt configured so that a toner image formed on the image-bearing member is transferred to the intermediate transfer belt at a primary transfer portion and is transferred to a recording material from the intermediate transfer belt at a secondary transfer portion, a cleaning blade configured to come into contact with a first contact portion of the intermediate transfer belt and clean toner remaining on an outer peripheral surface of the intermediate transfer belt, a scraper configured to come into contact with the outer peripheral surface of the intermediate transfer belt at a second contact portion downstream of the first contact portion in a rotation direction of the intermediate transfer belt, a driving source configured to drive the intermediate transfer belt in normal and reverse rotation, and a control unit configured to control the driving source so that a reverse rotation operation of reversely rotating the intermediate transfer belt is executed, wherein the scraper is provided on a lower surface of the intermediate transfer belt, and the control unit controls the driving source so that a moving distance of the intermediate transfer belt in the reverse rotation operation is longer than a circumferential distance L of the intermediate transfer belt between the first contact portion and the second contact portion.

Further features of the present disclosure will become apparent from the following description of exemplary embodiments with reference to the attached drawings.

### BRIEF DESCRIPTION OF THE DRAWINGS

FIG. 1 is a schematic cross-sectional view of an image forming apparatus according to an exemplary embodiment.

FIG. 2 is a schematic cross-sectional view of an intermediate transfer belt cleaning apparatus according to the present exemplary embodiment.

FIGS. 3A and 3B illustrate how a surface flaw is caused on an intermediate transfer belt.

FIGS. 4A to 4C illustrate how to eliminate scraped powder caught in a cleaning nip portion by a reverse rotation operation.

FIG. 5 is a control flowchart according to the present exemplary embodiment.

FIG. 6 is a control block diagram according to the present exemplary embodiment.

### DESCRIPTION OF THE EMBODIMENTS

### 1. Overall Configuration and Operation of Image Forming Apparatus

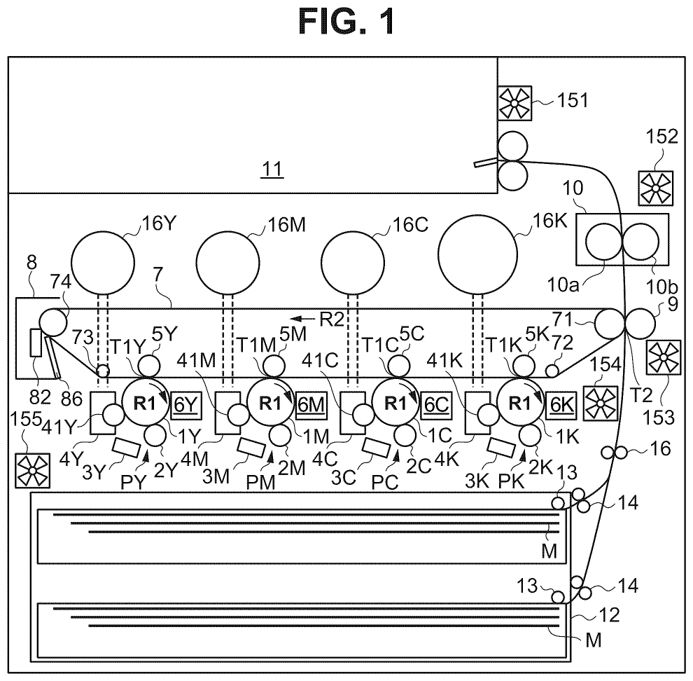

FIG. 1 is a schematic cross-sectional view of an image forming apparatus 100 according to an exemplary embodiment. The image forming apparatus 100 according to the present exemplary embodiment is a tandem-type laser beam printer that adopts an intermediate transfer method and can form a full-color image using an electrophotographic method.

The image forming apparatus 100 includes first to fourth image forming units PY, PM, PC, and PK as a plurality of image forming units (stations). The first to fourth image forming units PY, PM, PC, and PK are arranged linearly in this order along a rotation direction of an intermediate transfer belt 7, which is described below, and respectively form images of yellow (Y), magenta (M), cyan (C), and black (K).

In a case where there is no need to particularly distinguish between elements having similar functions and configurations provided corresponding to the respective image forming units PY, PM, PC, and PK, the Y, M, C, and K at the end of the reference numerals indicating that the element is for one of the colors are omitted, and the element is described in general terms. The elements for the respective colors are sometimes distinguished by adding Y, M, C, and K to the beginning of the term.

The image forming unit P includes a rotatable drum-type (cylindrical) electrophotographic photosensitive member (photosensitive drum) 1. The photosensitive member 1 serving as an image-bearing member is rotatively driven in an arrow R1 direction in FIG. 1. Following devices are arranged in order around the photosensitive member 1. A charging roller 2, which is a roller-type charging member serving as a charging unit, is arranged. An image exposure apparatus (laser scanner) 3 serving as an image exposure unit is arranged. A developing apparatus 4 serving as a developing unit is arranged. A primary transfer roller 5, which is a roller-type primary transfer member serving as a primary transfer unit, is arranged. A drum cleaning apparatus 6 serving as a photosensitive member cleaning unit is arranged.

The image forming apparatus 100 includes the intermediate transfer belt 7, which is formed of an endless belt to face the photosensitive members 1 of all the image forming units P and serves as another image-bearing member. The intermediate transfer belt 7 is an example of a mobile body that is cleaned by a cleaning blade 82, moves in an arrow R2 direction in FIG. 1, and bears and conveys a toner image to be transferred to a recording material to a contact portion (a secondary transfer portion T2) with the recording material. The intermediate transfer belt 7 is stretched around a plurality of supporting rollers 71 to 74 and is applied with a predetermined tensile force. If a drive roller 71, which is one of the plurality of supporting rollers 71 to 74, is rotatively driven, its driving force is transmitted to rotate the intermediate transfer belt 7 in the arrow R2 direction in FIG. 1. The above-described primary transfer rollers 5Y, 5M, 5C, and 5K are arranged at positions facing the respective photosensitive members 1Y, 1M, 1C, and 1K on an inner circumferential surface (back surface) of the intermediate transfer belt 7. The primary transfer roller 5 is pressed against the photosensitive member 1 via the intermediate transfer belt 7 and forms a primary transfer portion (primary transfer nip) T1 at which the intermediate transfer belt 7 and the photosensitive member 1 come into contact with each other. A secondary transfer roller 9, which is a roller-type secondary transfer member serving as a secondary transfer unit, is arranged at a position facing the drive roller 71, which is one of the plurality of supporting rollers 71 to 74, on an outer peripheral surface (front surface) of the intermediate transfer belt 7. The secondary transfer roller 9 forms the secondary transfer portion (secondary transfer nip) T2 at which the intermediate transfer belt 7 and the secondary transfer roller 9 come into contact with each other.

A belt cleaning apparatus 8 serving as an intermediate transfer cleaning unit is arranged at a position facing a tension roller 74 on the outer peripheral surface of the intermediate transfer belt 7.

The intermediate transfer belt 7 is described in detail. The intermediate transfer belt 7 includes a base layer and a surface layer provided on an outer peripheral surface of the base layer. The surface layer is a coating layer directly formed on the base layer to ensure releasability of the toner. In other words, the intermediate transfer belt 7 has a two-layer structure. However, the surface layer may include the coating layer and an adhesive layer that adheres the coating layer to the base layer. In other words, the intermediate transfer belt 7 may have a three-layer structure.

### [Base Layer]

The base layer is described. The base layer contains any of following resins: polyimide (PI), polyamide (PA), polyphenylene sulfide (PPS), polyetherimide (PEI), and polyether ether ketone (PEEK). The base layer is made of any of these resins in which an appropriate amount of a conductive filler such as carbon, an ionic conductive material, or the like is dispersed. Surface resistivity a of the base layer alone is 1.0*10⁹Ω/□≤α≤1.0*10¹³Ω/□, and desirably 6.3*10⁹Ω/□≤α≤3.2*10¹⁰Ω/□. A thickness D of the base layer satisfies 30 μm≤D≤100 μm.

### [Surface Layer]

The surface layer is described. The surface layer contains at least a binder resin and perfluoropolyether (PFPE). In other words, the surface layer mainly contains a binder resin, perfluoropolyether (PFPE), a dispersant, and other additives.

The binder resin contained in the surface layer is used to disperse PFPE, ensure adhesion to the base layer, and ensure a mechanical strength property. Examples of the binder resin according to the present exemplary embodiment include a styrene resin, an acrylic resin, a methacrylate resin, an epoxy resin, a polyester resin, a polyether resin, a silicone resin, and a polyvinyl butyral resin. Mixtures of these resins may also be used. Among the above-described binder resins, a methacrylate resin or an acrylic resin (hereinbelow, methacrylate resins and acrylic resins are collectively referred to as acrylic resins) is particularly desirably used.

Perfluoropolyether is an oligomer or a polymer including perfluoroalkylene ether as a repeating unit. Examples of the repeating unit of perfluoroalkylene ether include repeating units of perfluoromethylene ether, perfluoroethylene ether, and perfluoropropylene ether. It is desirable that the surface layer contains a dispersant for dispersing perfluoropolyether. Containing the dispersant can make a dispersed state of PFPE more stable in the surface layer.

As the dispersant, a compound having sites with affinity for perfluoroalkyl chains and hydrocarbons (a compound having both sites with high and low affinity for fluorine), such as a surface active agent, an amphiphilic block copolymer, and an amphiphilic graft copolymer is desirably used. According to the present exemplary embodiment, the intermediate transfer belt 7 having two or more layers is used, but the intermediate transfer belt 7 having a single layer may also be used.

The image forming apparatus 100 includes a feeding unit that feeds a recording material M and a fixing apparatus 10 serving as a fixing unit that fixes a toner image to the recording material M.

During image formation, a surface of the rotating photosensitive member 1 is charged substantially uniformly to a predetermined potential of a predetermined polarity (negative polarity in the present exemplary embodiment) by the charging roller 2 to which a charging bias is applied. In the rotation direction of the photosensitive member 1, small gaps are formed between the photosensitive member 1 and the charging roller 2 on upstream and downstream sides of a contact portion between the photosensitive member 1 and the charging roller 2. The charging roller 2 charges the surface of the photosensitive member 1 by discharging generated in at least one of the upstream and downstream gaps.

The charged surface of the photosensitive member 1 is subjected to image exposure (scanned and exposed) with a laser beam (not illustrated) based on image information by the image exposure apparatus 3, and an electrostatic latent image (electrostatic image) is formed on the photosensitive member 1. The electrostatic latent image formed on the photosensitive member 1 is developed (visualized) into a toner image by the developing apparatus 4 using toner as a developer. The developing apparatus 4 includes a developing roller 41 serving as a developer carrying member that carries and conveys the toner to a portion facing to the photosensitive member 1. During development, the developing roller 41 is applied with an oscillating voltage obtained by superimposing a direct current voltage and an alternating current voltage as a developing bias from a development power supply (not illustrated) serving as a developing bias applying unit. According to the present exemplary embodiment, a toner image is formed by exposing an image portion and reversal development. In other words, the toner charged with the same polarity as the charge polarity of the photosensitive member 1 adheres to an exposed portion on the photosensitive member 1 where an absolute value of the potential is reduced by exposure after being substantially uniformly charged.

The toner image formed on the photosensitive member 1 is transferred (primarily transferred) onto the intermediate transfer belt 7 at the primary transfer portion T1 by the primary transfer roller 5 to which a primary transfer bias is applied. In the rotation direction of the photosensitive member 1, a position where the photosensitive member 1 and the intermediate transfer belt 7 come into contact with each other and the toner image is transferred from the photosensitive member 1 to the intermediate transfer belt 7 is the primary transfer position (primary transfer portion) T1. For example, in a case where a full-color image is formed, the toner images of yellow, magenta, cyan, and black formed on the respective photosensitive members 1 are transferred onto the intermediate transfer belt 7 so as to be superimposed on one another at the respective primary transfer portions T1. The toner image formed on the intermediate transfer belt 7 is transferred (secondarily transferred) onto the recording material M at the secondary transfer portion T2 by the secondary transfer roller 9 to which a secondary transfer bias is applied. The recording material M is fed from a cassette 12 serving as a storage unit by a pickup roller 13, conveyed by a pair of conveyance rollers 14, and further conveyed to the secondary transfer portion T2 in synchronization with the toner image on the intermediate transfer belt 7 by a pair of registration rollers 16.

The recording material M on which the toner image is secondarily transferred is conveyed to the fixing apparatus 10, where the toner image is heated and pressed. Accordingly, the toner image is fixed to the recording material M. A temperature of the fixing apparatus 10 is determined by an environmental temperature sensor (not illustrated) and a setting of a paper type. Generally, if a process speed is the same, the temperature of the fixing apparatus 10 is set higher as an environmental temperature is lower and a basis weight of the set paper type is larger. According to the present exemplary embodiment, the paper types include plain paper 1, plain paper 2, and plain paper 3 with basis weights of 64 to 75 g/m², 76 to 90 g/m², and 91 to 105 g/m², respectively, and the temperatures of the fixing apparatus 10 are respectively set to 190° C., 200° C., and 210° C. at the environmental temperature of 23° C. After passing through the fixing apparatus 10, the recording material M is conveyed to a sheet discharge tray 11, and a series of image forming processes is completed.

As the recording material M, plain paper, a synthetic resin sheet, an envelope, or the like may be used, and according to the present exemplary embodiment, the recording material M is described as plain paper. The recording material M is selectively fed and conveyed one by one by the pickup roller 13 from the cassette 12 which is detachably arranged at a lower part of the main body of the image forming apparatus 100.

The surface of the photosensitive member 1 after the primary transfer process is cleaned by the drum cleaning apparatus 6. The drum cleaning apparatus 6 uses a cleaning blade (not illustrated) arranged in contact with the photosensitive member 1 to scrape off and remove an adhering substance such as primary transfer residual toner from the surface of the rotating photosensitive member 1 and collects the residual toner into a collection container.

A surface of the intermediate transfer belt 7 after the secondary transfer process is cleaned by the belt cleaning apparatus 8. The belt cleaning apparatus 8 uses the cleaning blade 82 arranged in contact with the intermediate transfer belt 7 to scrape off and remove an adhering substance such as secondary transfer residual toner (hereinbelow, referred to as transfer residual toner) from the surface of the intermediate transfer belt 7 and collects the adhering substance into the collection container.

The toner equivalent to a consumed amount is replenished from a toner bottle to the developing apparatus 4.

### 2. Belt Cleaning Apparatus

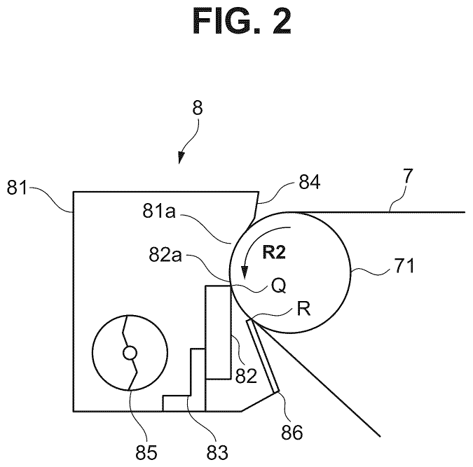

FIG. 2 is a schematic cross-sectional configuration view of the belt cleaning apparatus 8 according to the present exemplary embodiment. FIG. 2 illustrates a cross section substantially perpendicular to a movement direction of the surface of the intermediate transfer belt 7.

The belt cleaning apparatus 8 includes a collection container (casing) 81 having an opening portion 81a toward an intermediate transfer belt 7. The cleaning blade 82 and a cleaning scraper 86 are attached to the opening portion 81a of the collection container 81 via a support member 83. The cleaning blade 82 and the cleaning scraper 86 are arranged in a direction substantially perpendicular to a movement direction R2 of the surface of the intermediate transfer belt 7 (a width direction of the intermediate transfer belt 7).

The cleaning blade 82 and the cleaning scraper 86 are plate-shaped members of predetermined thicknesses and having predetermined lengths in a longitudinal direction and in a transverse direction perpendicular to the longitudinal direction, respectively.

According to the present exemplary embodiment, the cleaning blade 82 is formed of urethane rubber as an elastic material. One end of the cleaning blade 82 in its transverse direction is fixed to the support member 83, and the support member 83 is fixed to the collection container 81. An outer edge portion 82a of a tip end on a free end in the transverse direction of the cleaning blade 82 is brought into contact with the intermediate transfer belt 7 in a counter direction with respect to the conveyance direction of the intermediate transfer belt 7. In other word, the cleaning blade 82 is brought into contact with the surface of the intermediate transfer belt 7 so that its tip end on the free end faces an upstream side in the movement direction of the surface of the intermediate transfer belt 7 during image formation. A contact portion between the cleaning blade 82 and the intermediate transfer belt 7 is a cleaning nip (cleaning portion) Q as a first contact portion.

The cleaning scraper 86 is disposed downstream of the cleaning blade 82 and is formed of a polyester member as a resin material. The cleaning scraper 86 is brought into contact with the intermediate transfer belt 7 in the counter direction with respect to the conveyance direction of the intermediate transfer belt 7. In other word, the cleaning scraper 86 is brought into contact with the surface of the intermediate transfer belt 7 so that its tip end on the free end faces the upstream side in the movement direction of the surface of the intermediate transfer belt 7 during image formation. A contact portion between the cleaning scraper 86 and the intermediate transfer belt 7 is a cleaning nip (cleaning portion) R as a second contact portion. According to the present exemplary embodiment, a polyester-based material is used, but any material having a higher hardness than the cleaning blade 82 may be used, for example, a metal member, an acrylonitrile butadiene styrene (ABS) material, or a polyethylene terephthalate (PET) member. The cleaning scraper 86 is configured to be thinner than the cleaning blade 82.

At the opening portion 81a of the collection container 81, a scooping sheet 84 serving as a contact member is attached upstream of the cleaning blade 82 in the movement direction of the surface of the intermediate transfer belt 7. The scooping sheet 84 is a sheet-shaped member of a predetermined thickness that is arranged in the direction substantially perpendicular to the movement direction of the surface of the intermediate transfer belt 7 and has predetermined lengths in the longitudinal direction and in the transverse direction perpendicular to the longitudinal direction, respectively. According to the present exemplary embodiment, the scooping sheet 84 is formed of a flexible plastic sheet. One end of the scooping sheet 84 in its transverse direction is fixed to and supported by the collection container 81. A tip end of the scooping sheet 84 on the free end in its transverse direction is in contact with the intermediate transfer belt 7. The scooping sheet 84 is brought into contact with the intermediate transfer belt 7 so that the tip end on the free end faces a downstream side in the movement direction of the surface of the intermediate transfer belt 7 during image formation. The scooping sheet 84 drops the toner scraped off by the cleaning blade 82 into the collection container 81 and suppresses the toner from flowing back toward the intermediate transfer belt 7. A conveyance screw 85 is arranged in the collection container 81 to convey the collected toner in the longitudinal direction and discharge the collected toner to a collected toner box (not illustrated), which is separately provided in the image forming apparatus 100.

### 3. Developer

The developing apparatus 4 develops the electrostatic image on the photosensitive member 1 using a two-component developer that is a mixture of carrier (magnetic) and toner (non-magnetic). A developer in which the carrier and toner are mixed in a weight ratio of 91:9 (toner concentration: 9%) is used. A total weight of the initial developer stored in the developing apparatus 4 is set to 208 g.

The carrier used is made of ferrite particles coated with silicone resin and has a saturation magnetization of 24 [Am²/kg] with respect to an applied magnetic field of 240 [kA/m]. Its specific resistance at an electric field strength of 3000 [V/cm] is 1*10⁷ [Ω·cm] to 1*10⁸ [Ω·cm], and a weight average particle size is 50 μm.

The toner contains at least a binder, a colorant, and a charge control agent. A styrene-acrylic resin is used as a binder resin. Styrene-based, polyester-based, polyethylene and other resins can also be used. As the colorant, various pigments and various dyes may be used alone or in combination of a plurality of kinds. As the charge control agent, a charge control agent for reinforcement may be contained as necessary. As the charge control agent for reinforcement, a nigrosine-based dye, a triphenylmethane-based dye, and the like can be used.

The toner contains wax. The wax is contained to improve the releasability from a fixing member and a fixing property during fixing. As the wax, paraffin wax, carnauba wax, polyolefin, and the like can be used, and it is used by being kneaded and dispersed in the binder resin. A resin in which a binder, a colorant, a charge control agent, and wax are kneaded and dispersed is ground by a mechanical grinding mill and used. A melting point of the wax used in the present exemplary embodiment is 100° C. or lower.

The toner contains an external additive. Examples of the external additive include amorphous silica subjected to a hydrophobic treatment or inorganic oxide particles such as titanium oxide and a titanium compound. Fine particles of these materials are added to the toner to adjust powder flowability and charge amount of the toner. A particle diameter of the external additive particle is desirably 1 nm or more and 100 nm or less. Titanium oxide having an average particle diameter of 50 nm is added at a weight ratio of 0.5 wt %, and amorphous silica having average particle diameters of 2 nm and 100 nm are added at 0.5 wt % and 1.0 wt %, respectively.

A particle diameter of the toner having the above-described configuration was measured using a flow particle image analyzer FPIA-3000 manufactured by Sysmex, and a weight average particle diameter was 6.6 μm.

### 4. Image Defect Caused by Surface Flaw on Intermediate Transfer Belt

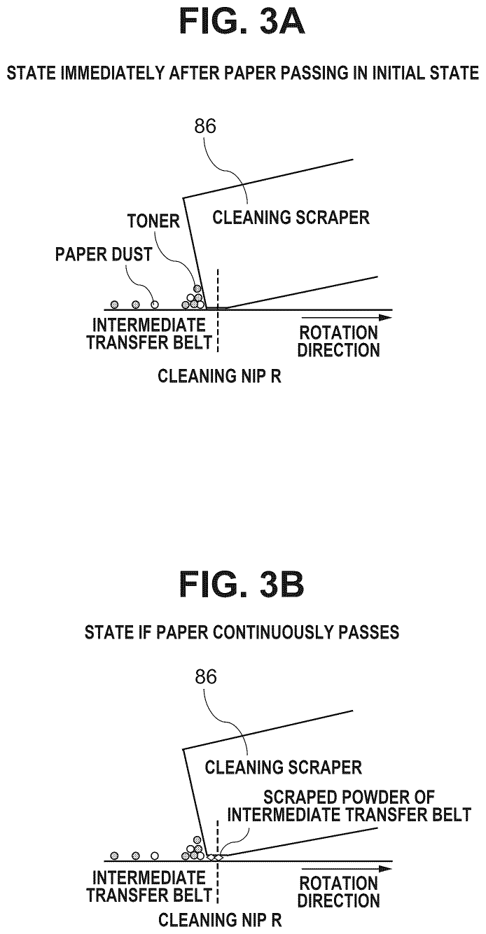

An image defect caused by a surface flaw on the intermediate transfer belt 7 is described with reference to FIGS. 3A and 3B. The cleaning blade 82 generates minute vibrations during the cleaning operation, so that a small gap is generated between the intermediate transfer belt 7 and the cleaning blade 82. The adhering substances (toner, paper dust, etc.) on the intermediate transfer belt 7 may pass through the gap and sneak through the cleaning blade 82 in some cases. The toner and paper dust that have sneaked through the cleaning blade 82 are collected by the cleaning scraper 86 as illustrated in FIG. 3A. In a state immediately after an initial use of the main body, there is nothing present in the cleaning nip R portion between the intermediate transfer belt 7 and the cleaning scraper 86.

If the paper continues to pass after that, as illustrated in FIG. 3B, the surface layer of the intermediate transfer belt 7 is scraped off by sliding between the intermediate transfer belt 7 and the cleaning scraper 86 because the material used for the cleaning scraper 86 is relatively hard. Thus, the scraped powder of the intermediate transfer belt 7 is caught in the cleaning nip R portion. If the intermediate transfer belt 7 continues to rotate in a state where the scraped powder of the intermediate transfer belt 7 is caught in the cleaning nip R portion, a following defect may occur. Specifically, the scraped powder caught in the cleaning nip R portion continuously forms flaws, and surface flaws of about several micrometers are locally formed on the intermediate transfer belt 7. There is a risk of causing cleaning failure and a transfer failure image due to an effect of the surface flaws.

### 5. Efficient Discharge Control of Scraped Powder Caught in Cleaning Nip R Portion (Reverse Rotation Control)

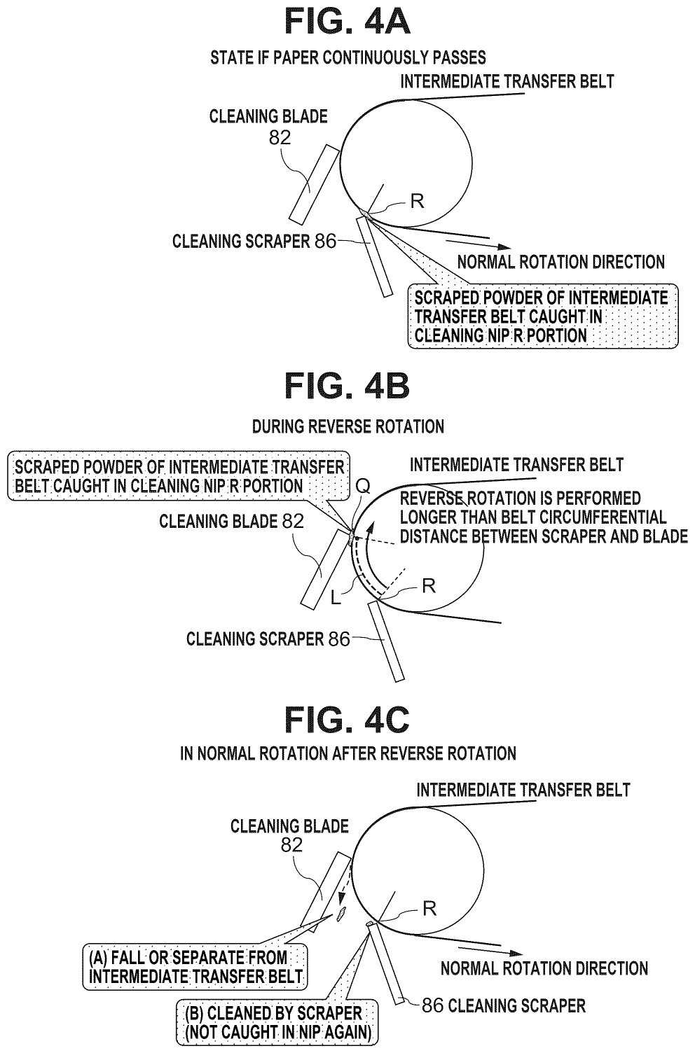

A unit according to the present exemplary embodiment that removes the scraped powder of the intermediate transfer belt 7 caught in the cleaning nip R portion is described with reference to FIGS. 4A to 4C.

As illustrated in FIG. 4A, if the paper continues to pass through, the surface layer of the intermediate transfer belt 7 is scraped off by sliding between the intermediate transfer belt 7 and the cleaning scraper 86, and the scraped powder of the intermediate transfer belt 7 is caught in the cleaning nip R portion. As described above, if the intermediate transfer belt 7 continues to rotate in the state where the scraped powder of the intermediate transfer belt 7 is caught in the cleaning nip R portion, there is a risk of occurrence of the local flaw and cleaning failure.

As illustrated in FIG. 4B, reverse rotation control is performed on the intermediate transfer belt 7 to prevent the surface flaw on the intermediate transfer belt 7. According to the present exemplary embodiment, the reverse rotation control is performed so that an operation distance (moving distance) of the reverse rotation is longer than a belt circumferential distance L between the cleaning scraper 86 and the cleaning blade 82. In other words, a reverse rotation operation is performed so that the operation distance of the reverse rotation is longer than or equal to the circumferential distance L of the intermediate transfer belt 7 between the cleaning nip Q portion, which is the first contact portion, and the cleaning nip R portion, which is the second contact portion. In this way, the scraped powder caught in the cleaning nip R portion collides with the cleaning nip Q portion between the cleaning blade 82 and the intermediate transfer belt 7, so that the scraped powder can be collected or a shape of the scraped powder can be destroyed. Specifically, according to the present exemplary embodiment, the cleaning scraper 86 is configured to come into contact with a lower surface of the intermediate transfer belt 7 as illustrated in FIGS. 4A to 4C. In other words, an area can be provided in which the outer peripheral surface of the intermediate transfer belt 7 faces downward in an area of the intermediate transfer belt 7 between the cleaning nip Q portion, which is the first contact portion, and the cleaning nip R portion, which is the second contact portion. Thus, even if the scraped powder caught in the cleaning nip R portion does not fall from the intermediate transfer belt 7 during the reverse rotation operation, it is possible to cause the scraped powder to fall before it reaches the second contact portion again by a normal rotation operation after the reverse rotation operation. In other words, it is possible to suppress a defect that the scraped powder caught in the cleaning nip R portion is discharged by the reverse rotation operation and then is sent back to the contact portion of the cleaning scraper 86 by the next normal rotation operation. According to the present exemplary embodiment, the cleaning blade 82 is configured to come into contact with a side surface (left side surface in the present exemplary embodiment) of the intermediate transfer belt 7 as illustrated in FIGS. 4A to 4C. Further, the cleaning blade 82 is configured to come into contact with an area in which the movement direction of the intermediate transfer belt 7 is downward in a vertical direction. For this reason, if the reverse rotation operation is performed for the circumferential distance L of the intermediate transfer belt 7 or longer, the scraped powder caught in the cleaning nip R portion can be efficiently dropped by its own weight when it collides with the cleaning nip Q portion.

An effect of performing the reverse rotation control with the operation distance of the reverse rotation longer than the belt circumferential distance L between the cleaning scraper 86 and the cleaning blade 82 is described. In a case where the scraped powder caught in the cleaning nip R portion is removed by the reverse rotation operation, the scraped powder adheres or attaches to the intermediate transfer belt 7 with a strong force. A case is considered in which the operation distance of the reverse rotation is less than the belt circumferential distance L between the cleaning scraper 86 and the cleaning blade 82. In this case, the scraped powder once caught in the cleaning nip R portion is removed from the cleaning nip R by the reverse rotation operation, but the scraped powder enters the cleaning nip R portion again without changing its shape. Accordingly, there is a possibility that the scraped powder will be caught in the cleaning nip R portion again, so that the effect of removing the scraped powder is limited.

As illustrated in FIG. 4C, a case is considered in which the operation distance of the reverse rotation is the belt circumferential distance L between the cleaning scraper 86 and the cleaning blade 82 or longer. In this case, if the reverse rotation operation is performed, the scraped powder caught in the cleaning nip R portion collides with the cleaning nip Q portion and falls from the intermediate transfer belt 7 or changes its shape. The scraped powder adhering to the intermediate transfer belt 7 without falling will fall or separate from the intermediate transfer belt 7 by the normal rotation operation after the reverse rotation operation (A). In a case where the scraped powder does not fall or separate and enters the cleaning scraper 86 again, the scraped powder is cleaned and collected without being caught in the cleaning nip R portion of the cleaning scraper 86 (B).

Thus, it is desirable to periodically perform the reverse rotation control for a distance longer that the belt circumferential distance L between the cleaning scraper 86 and the cleaning blade 82. Accordingly, the scraped powder caught in the cleaning nip R portion collides with the cleaning blade 82 and is finally collected by either the cleaning blade 82 or the cleaning scraper 86, so that flaw formation on the intermediate transfer belt 7 can be suppressed.

### 6. Detail of Control Mode of Present Exemplary Embodiment

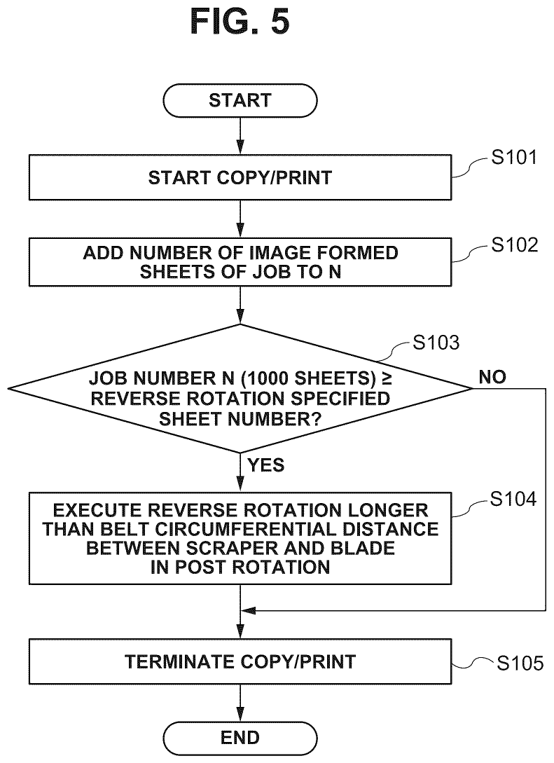

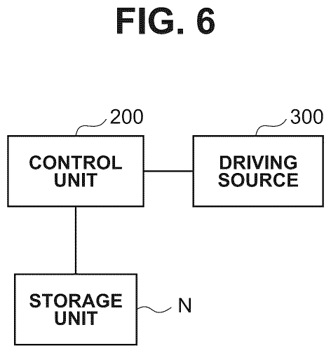

FIG. 5 is a flowchart diagram illustrating processing from a start of a job to execution of the reverse rotation control in the image forming apparatus 100 according to the first exemplary embodiment of the present disclosure. FIG. 6 is a control block diagram for executing a control flow. The control flow is calculated and determined by a control unit 200 provided in the image forming apparatus 100. The flowchart diagram is described in detail below with an example.

For example, in step S101, if the control unit 200 receives a print start signal in the image forming apparatus 100 according to the present exemplary embodiment, in step S102, the control unit 200 adds a cumulated number of sheets (the number of sheets on which an image is formed) since the previous reverse rotation control is performed to a storage unit N. According to the present exemplary embodiment, an initial value of a job number N is zero.

In step S103, if the job number N exceeds a reverse rotation specified sheet number (YES in step S103), the control unit 200 performs the next reverse rotation operation in a post rotation period after a final page of the job is printed. In other words, in step S104, the control unit 200 controls a driving source 300 serving as a driving unit of the intermediate transfer belt 7 to reversely rotate the intermediate transfer belt 7. The control unit 200 controls a reverse rotation amount of the intermediate transfer belt 7 to be larger than the belt circumferential distance L between the cleaning scraper 86 and the cleaning blade 82. In step S105, the copy/print operation is terminated. If the job number N does not exceed the reverse rotation specified sheet number (NO in step S103), in step S105, the control unit 200 terminates the copy/print operation without performing the reverse rotation operation.

A pre-rotation and a post-rotation of a job described in FIG. 5 according to the present exemplary embodiment are respectively a pre-preparation operation and a post-preparation operation for executing a print job. The preparation operations include starting and stopping driving of the photosensitive member 1, the developing apparatus 4, and the intermediate transfer belt 7, and starting and stopping application of a high voltage to the charging roller 2, the developing roller 41, the primary transfer roller 5, and the secondary transfer roller 9. Details of control sequences for the pre-rotation and the post-rotation are omitted.

The reverse rotation operation according to the present exemplary embodiment is set in the post-rotation for the job number N of 1000 sheets or more, but is not limited to this example, and may be performed every post-rotation or as an inter-sheet operation.

Apart from the reverse rotation operation according to the present exemplary embodiment, a following reverse rotation operation (second reverse rotation operation) may be performed. In other words, in order to remove paper dust or the like stuck in the cleaning blade or to reduce deformation of the cleaning blade, the intermediate transfer belt 7 may be reversely rotated under predetermined conditions (each post-rotation/a cumulated number of sheets, or the like). The predetermined conditions for executing the second reverse rotation operation may be different from conditions for executing the first reverse rotation operation. An operation amount of the second reverse rotation operation may be smaller than that of the above-described reverse rotation operation.

The present disclosure has been described with reference to the specific examples, but the present invention is not limited to the above-described present exemplary embodiments.

According to the present disclosure, it is possible to provide an image forming apparatus that is equipped with a scraper that removes an adhering substance adhering to a surface of an image-bearing member and is capable of removing a deposited substance deposited on a scraper contact portion with a simple configuration.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-062417, filed Apr. 8, 2024, which is hereby incorporated by reference herein in its entirety.

What is claimed is:

1. An image forming apparatus comprising:
an image bearing member configured to rotate and bear a toner image;
an intermediate transfer belt configured so that a toner image formed on the image bearing member is transferred at a primary transfer portion and is transferred to a recording material at a secondary transfer portion;
a cleaning blade configured to come into contact with a first contact portion of the intermediate transfer belt and clean toner remaining on an outer peripheral surface of the intermediate transfer belt;
a scraper configured to come into contact with the outer peripheral surface of the intermediate transfer belt at a second contact portion downstream of the first contact portion in a rotation direction of the intermediate transfer belt;
a driving source configured to drive the intermediate transfer belt in normal and reverse rotation; and
a control unit configured to control the driving source so that a reverse rotation operation of reversely rotating the intermediate transfer belt is executed,
wherein the scraper is configured to come into contact with a lower surface of the intermediate transfer belt, and the control unit controls the driving source so that a moving distance of the intermediate transfer belt in the reverse rotation operation is longer than a circumferential distance L of the intermediate transfer belt between the first contact portion and the second contact portion.

2. The image forming apparatus according to claim 1, wherein the reverse rotation operation is executed in a state where the cleaning blade is in contact with the intermediate transfer belt.

3. The image forming apparatus according to claim 1, wherein the control unit executes the reverse rotation operation based on a number of sheets on which an image is formed.

4. The image forming apparatus according to claim 1, wherein the reverse rotation operation is a first reverse rotation operation that is executed under a first condition, and the control unit is configured to execute a second reverse rotation operation that is executed under a second condition and is different from the first reverse rotation operation.

5. The image forming apparatus according to claim 1, wherein a thickness of the scraper is smaller than that of the cleaning blade.

6. The image forming apparatus according to claim 1, wherein a hardness of the scraper is higher than that of the cleaning blade.

7. The image forming apparatus according to claim 1, wherein the scraper is a resin member, and the cleaning blade is an elastic member.

8. An image forming apparatus comprising:
an image bearing member configured to rotate and bear a toner image;
an intermediate transfer belt configured so that a toner image formed on the image bearing member is transferred at a primary transfer portion and is transferred to a recording material at a secondary transfer portion;
a cleaning blade configured to come into contact with a first contact portion of the intermediate transfer belt and clean toner remaining on an outer peripheral surface of the intermediate transfer belt;
a scraper configured to come into contact with the outer peripheral surface of the intermediate transfer belt at a second contact portion downstream of the first contact portion in a rotation direction of the intermediate transfer belt;
a driving source configured to drive the intermediate transfer belt in normal and reverse rotation; and
a control unit configured to control the driving source so that a reverse rotation operation of reversely rotating the intermediate transfer belt is executed,
wherein the cleaning blade is configured to come into contact with a side surface of the intermediate transfer belt and to come into contact with an area where the intermediate transfer belt moves downward in a vertical direction, and the control unit controls the driving source so that a moving distance of the intermediate transfer belt in the reverse rotation operation is longer than a circumferential distance L of the intermediate transfer belt between the first contact portion and the second contact portion.

9. The image forming apparatus according to claim 8, wherein the reverse rotation operation is executed in a state where the cleaning blade is in contact with the intermediate transfer belt.

10. The image forming apparatus according to claim 8, wherein the control unit executes the reverse rotation operation based on a number of sheets on which an image is formed.

11. The image forming apparatus according to claim 8, wherein the reverse rotation operation is a first reverse rotation operation that is executed under a first condition, and the control unit is configured to execute a second reverse rotation operation that is executed under a second condition and is different from the first reverse rotation operation.

12. The image forming apparatus according to claim 8, wherein a thickness of the scraper is smaller than that of the cleaning blade.

13. The image forming apparatus according to claim 8, wherein a hardness of the scraper is higher than that of the cleaning blade.

14. The image forming apparatus according to claim 8, wherein the scraper is a resin member, and the cleaning blade is an elastic member.
